(19) United States
(12) Patent Application Publication
(10) Pub. No.: US 2013/0171476 A1
(43) Pub. Date: Jul. 4, 2013

(54) SECONDARY BATTERY

(71) Applicants: Woon-Seong Baek, Yongin-si (KR); Sang-Joo Lee, Yongin-si (KR); Heui-Sang Yoon, Yongin-si (KR)

(72) Inventors: Woon-Seong Baek, Yongin-si (KR); Sang-Joo Lee, Yongin-si (KR); Heui-Sang Yoon, Yongin-si (KR)

(73) Assignee: Samsung SDI Co., Ltd., Yongin-si (KR)

(21) Appl. No.: 13/620,331

(22) Filed: Sep. 14, 2012

(30) Foreign Application Priority Data
Jan. 4, 2012 (KR) 10-2012-0001007

(51) Int. Cl. H01M 2/02; H01M 2/00

(52) U.S. Cl. 429/7

(57) ABSTRACT

Mechanical connections between a fixing member, a bare secondary battery cell and a protection circuit module by pressurizing a bare cell by a fastening member are disclosed. The secondary battery is capable of stably fixing an upper case and the bare cell. The secondary battery may include a bare cell including an electrode assembly in the inside thereof and formed with a fixing groove in both sides of a top surface; a protection circuit module electrically connected to the bare cell; and an upper case surrounding the protection circuit module and formed with the fastening hole in the position corresponding to the fixing groove. A bottom surface of the upper case not formed with the fastening hole may be formed with an adhering portion contacting the top surface of the bare cell and a space portion not contacting the top surface of the bare cell.

### CROSS-REFERENCE TO RELATED APPLICATIONS

This application claims priority to and the benefit of Korean Patent Application No. 10-2012-0001007, filed on Jan. 4, 2012, in the Korean Intellectual Property Office, the entire content of which is incorporated herein by reference.

### BACKGROUND

1. Field

Embodiments of the present disclosure relate to a secondary cell, and more particularly, to the secondary cell capable of stably fixing an upper case and a bare cell.

2. Description of the Related Art

Secondary batteries are classified into a square battery, a cylindrical battery, etc, according to a shape.

Since deterioration or heating may be caused by overcharge or overdischarge in the secondary battery, minimum values and maximum values of voltage or temperature etc. should be controlled. To this end, the secondary battery is included with a protection circuit module, and the protection circuit module may include a secondary protection device.

The secondary protection device is vulnerable to external shocks or heat and is easily damaged, thereby to need caution when manufacturing and handling. In recent, since portable electronic devices tend to be lighter and smaller, it is difficult to significantly protect the secondary battery from the external shocks by exterior only of the electronic devices.

### SUMMARY OF THE INVENTION

The development of the secondary battery, capable of preventing the damage of the protection circuit module by the secondary battery itself by stably fixing the bare cell to the upper case, is needed.

An advantage of some embodiments of the disclosure is that it provides a secondary battery capable of reinforcing a fastening force of a fastening member by forming a space portion not contacting a bare cell in a lower surface of an upper case, when fixing a bare cell and an upper case from each other using a fastening member.

Another advantage of some embodiments of the disclosure is that it provides a secondary battery of capable of improving adhesion between a fixing member, between the bare cell and the protection circuit module, and the bare cell by pressurizing the bare cell by a fastening member, and stably fixing the upper case and the bare cell.

The secondary battery of the invention includes a bare cell including an electrode assembly in the inside thereof and formed with a fixing groove in both sides of a top surface, a protection circuit module electrically connected to the bare cell, and an upper case surrounding the protection circuit module and formed with the fastening hole in the position corresponding to the fixing groove. A bottom surface of the upper case not formed with the fastening hole is formed with an adhering portion contacting the top surface of the bare cell and a space portion not contacting the top surface of the bare cell.

Here, the space portion may be formed in both side ends of the bottom surface of the upper case.

Preferably, the space portion may be spaced by the range of about 0.02 mm to about 0.2 mm from the bare cell.

More preferably, the space portion may be spaced by about 0.05 mm from the bare cell.

Further, the secondary battery further include the fastening member penetrating the fastening hole of the upper case and fastened to the fixing groove of the bare cell.

The fastening member may be formed as a bolt, and the fixing groove may be formed in the shape of a nut to which the bolt may be fastened.

In addition, the fastening hole of the upper case may be formed with a seated portion formed to be stepped so that a head portion of the bolt is seated.

Further, the fastening member may be formed as a rivet.

Further, the bare cell and the protection circuit module may be electrically connected by the fixing member.

The fixing member includes a first side formed with the fixing hole, and a second side not formed with the fixing hole.

Further, the first side of the fixing member is corresponded to the fixing groove of the bare cell, and the second side of the fixing member may be connected to the bottom surface of the protection circuit module.

Further, in the fixing member, the first side is stepped to the second side, and the second side may be formed higher.

Further, the space portion may be further formed with an insulation member.

In addition, the upper case may be further formed with an opening exposed with a terminal of the protection circuit module.

The protection circuit module further includes a secondary protection device.

In an embodiment, a secondary battery is provided. The secondary battery comprises a casing dimensioned to receive an electrode assembly and formed with a fixing groove in at least one side of a top surface of the casing. The secondary battery further comprises a protection circuit module electrically connected to the casing and positioned adjacent to the top surface of the casing. The secondary battery additionally comprises an upper case surrounding at least a portion of the protection circuit module and formed with a through hole, the upper case positioned with respect to the casing such that the fixing groove and through hole are substantially aligned concentric.

A bottom surface of the upper case is formed with a first portion contacting the top surface of the casing and a space portion spaced apart at a selected distance from the top surface of the casing.

The space portion does not contact the casing.

The space portion reduces the area of the upper case contacting the top surface of the casing as compared to an upper case without the space portion.

In an embodiment, the selected distance is between about 0.02 mm to about 0.2 mm. In an alternative embodiment, the selected distance is between about 0.05 mm to about 0.2 mm

The secondary battery, further comprising a fastening member extending between the fixing groove and the through hole so as to mechanically secure the casing to the upper case.

The secondary battery further comprises a fixing member. The fixing member comprises a first end and a second end, wherein the fixing member is bent such that the second end is positioned above the first end and a fixing hole formed in the first side. The fixing member is positioned such that the fastening member extends through the fixing hole.

The second end of the fixing member supports an end of the protection circuit module.

The second end of the fixing member positioned the protection circuit module at a selected distance from the top surface of the casing.

The secondary battery further comprises an insulation member positioned in at least a portion of the space portion.

### BRIEF DESCRIPTION OF THE DRAWINGS

The accompanying drawings, together with the specification, illustrate embodiments of the present disclosure, and, together with the description, serve to explain the principles of the present disclosure.

FIG. 1 is a perspective view of a secondary battery according to an embodiment of the present disclosure.

FIG. 2 is a cross-sectional view taken by line A-A′ of FIG. 1.

FIG. 3 is a perspective view showing an upper case according to an embodiment of the present disclosure.

FIG. 4 is a perspective view showing a protection circuit module and a fixing member according to an embodiment of the present disclosure.

FIG. 5 is a bottom perspective view showing a protection circuit module and a fixing member according to an embodiment of the present disclosure.

FIG. 6 is a perspective view showing a top of a bare cell according to an embodiment of the present disclosure.

FIG. 7 is a perspective view showing a secondary battery according to another embodiment of the present disclosure.

### DETAILED DESCRIPTION OF THE PREFERRED EMBODIMENT

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive.

In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, it is in detail described about embodiments of the present disclosure and matters allowing one of ordinary skill in the art to require to easily understand the content of the present disclosure, with reference to the drawings. Therefore, embodiments described above are for illustration purpose in all respect but not limited to them.

In the description of the present disclosure, when the detailed description for the known technology to be related may blur the gist of the present disclosure, the detailed description will be omitted. Hereinafter, like reference numerals refer to like elements. In addition, the thickness or size of each layer in the drawing may be exaggerated for the sake convenience of description and clarity, and may differ from actual size and thickness of the layer.

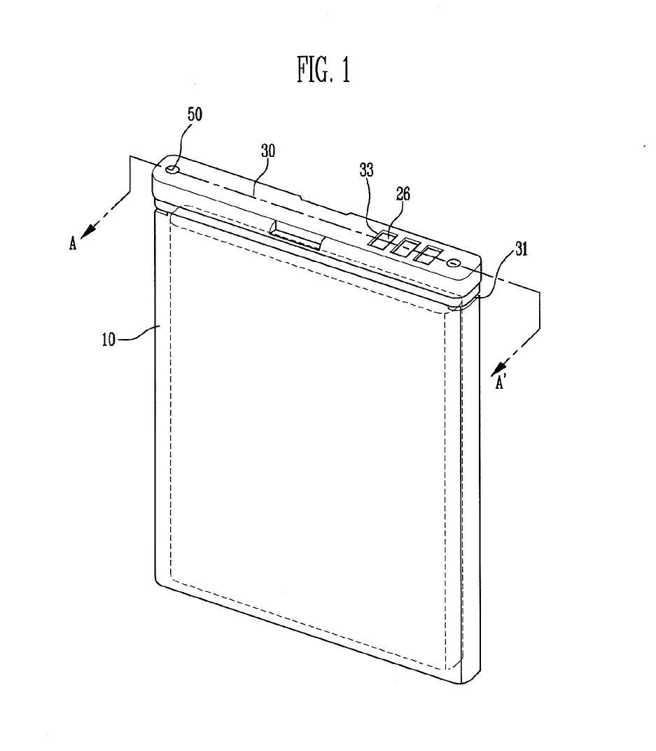

FIG. 1 is a perspective view showing a secondary battery according to an embodiment of the present disclosure.

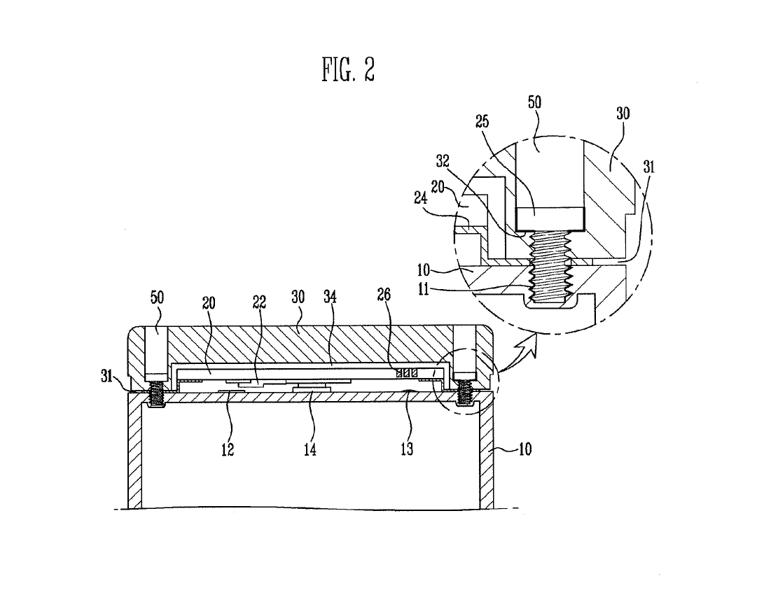

According to an embodiment of the present disclosure, FIG. 1 shows a secondary cell into which a bare cell 10, a protection circuit module 20 (refer to FIG. 2), and an upper case 30 are combined. The protection circuit module 20 is electrically connected to the bare cell 10, and the upper case 30 surrounds the protection circuit module 20 and is fastened to the top of the bare cell 10.

The upper case 30 is formed with an opening 33 allowing a terminal 26 of the protection circuit module 20 to be exposed and with a plurality of fastening holes 50. In an embodiment, the plurality of fastening holes 50 may be formed adjacent to the sides of the upper case 30. For example, as illustrated in FIG. 1, two fastening holes 50 are formed in both sides of the upper case 30, respectively. The fastening holes 50 may extend through the upper case 30 from a top surface to a bottom surface. A portion of the bottom surface of the upper case 30, in which the fastening hole 50 is not formed, is further formed with a space portion 31. In certain embodiments, the space portion does not contact the top surface of the bare cell 10. The space portion 31 may be a plurality of space portions 31 formed in both ends of the bottom surface of the upper case 30.

According to an embodiment of the present disclosure, the fastening hole 50 is penetrated with a fastening member 25 (refer to FIG. 2) and fastened to a fixing groove 11 (refer to FIG. 2) of the bare cell 10, thereby to mechanically secure the bare cell 10 and the upper case 30.

Like this, when combining the bare cell 10 and the upper case 30 by the fastening member 25, the fastening member 25 should be have a structure so that at least a portion of the fastening force of the fastening member 25 may be in its transferred to the bare cell 10 and the upper case 30. In further embodiments, substantially all of the fastening force of the fastening member 25 may be transferred to the bare cell 10 and the upper case 30.

However, in the region in which the upper case 30 contacts the bare cell 10, there is a problem in that the upper case 30 does not combine into a correct position of the top surface of the bare cell 10 according to a welding bead. That is, the upper case 30 is inclined, or the position is twisted, thereby to lower the fastening force of the fastening member 25.

When the fastening member 25 is not fastened goodly, the fastening member 25 spins with no traction by the welding bead of the bare cell 10, such that the bare cell 10 may be crushed. Further, the fastening member 25 and the upper case 30 may be damaged. To solve above problem, a space portion 31 is formed in at least one of the ends the bottom surface of the upper case 30 in the disclosure, and described in detail with reference to the following drawings.

FIG. 2 is a cross-sectional view taken by line A-A′ of FIG. 1.

According to an embodiment of the present disclosure, in FIG. 2, the secondary battery includes the bare cell 10, the protection circuit module 20, and the upper case 30.

The inside of the bare cell 10 is included with an electrode, and at least one side of the top surface of the bare cell 10 is formed with fixing grooves 11. Further, the protection circuit module 20 is positioned on the top of the bare cell 10, and is electrically connected to the bare cell 10 by the fixing member 24.

At this time, the fixing member 24 includes a first side formed with the fixing hole 23, and a second side not formed with the fixing hole 23. In one embodiment, the first side of the fixing member 24 is corresponded to the fixing groove 11 of the bare cell 10. For example, the cross-sectional dimensions of the fixing hole 23 of the fixing member 24 and fixing groove 11 may be approximately the same. In another embodiment, the second side of the fixing member 24 may be connected to the bottom surface of the protection circuit module 20. Here, the fixing hole 23 of the first side of the fixing member 24 is corresponded to the fixing groove 11 of the bare cell 10.

Further, in the fixing member 24, the first side is stepped with respect to the second side, and the second side may be formed higher (e.g., bent in an approximate “Z” shape). The PCM may be attached to the fixing member 24 at the second end so as to be supported and positioned away from the top surface of the bare cell 10. Thereby, there is a space formed between the protection circuit module 20, connected to the second side of the fixing member 24, and the bare cell 10. Thereby, the space is positioned with an electrode terminal 14, a vent 12 and an electrolyte inlet 13 etc. protruded from the top surface of the bare cell 10. Further, a secondary protection device 22 etc. formed in the bottom surface of the protection circuit module 30 may be positioned within the space.

The upper case 30 substantially surrounds the protection circuit module 20, and is coupled with the top of the bare cell 10. The upper case 30 is formed with the fastening hole 50 in about the position corresponding to the fixing groove 11 of the bare cell 10. A separate fastening member 25 is inserted into the fastening hole 50, penetrates the fixing hole 23 of the fixing member 24, and then, is fastened to the fixing groove 11 of the bare cell 10.

At this time, a lower surface of the upper case 30, in which the fastening hole 50 is not formed, is formed with a space portion 31 not contacting the top surface of the bare cell 10. In an embodiment, the space portion 31 may be formed in at least one end of the lower surface of the upper case 30. Preferably, the space portion 31 may be formed in both ends of the lower surface of the upper case 30.

Thereby, it may be prevented that the upper case 30 is inclined or twisted by a welding bead of the bare cell 10 by reducing the area of the upper case 30 adjacent to or contacting the top surface of the bare cell 10. Further, the fastening force of the fastening member 25 is improved and therefore, pressurizes the bare cell 10, thereby to improve adhesion between the fixing member 24 and the bare cell 10. In addition, the bare cell 10 may be further stably coupled with the upper case 30.

The space portion 31 may be spaced by the range of about 0.02 mm to about 0.2 mm from the bare cell 10. If the space between the space portion 31 and the bare cell 10 is spaced by less than about 0.02 mm, there is a risk that the upper case 30 touches the welding bead of the bare cell 10, and therefore, it is unnecessary to form the space portion 31. Further, if the space between the space portion 31 and the bare cell 10 is spaced in excess of about 0.2 mm, an outer wall of the upper case 30 formed with the fastening hole 50 is slimmer, thereby to have the risk to be damaged. Here, it preferable that the space portion 31 is spaced apart from the bare cell 10 by at least about 0.05 mm. It is the most preferable that the space portion 31 is spaced apart from the bare cell 10 by about 0.05 mm.

In an embodiment, the fastening member 25 coupling the bare cell 10 with the upper case 30 may be formed a generally elongate fastener configured to extend within at least a portion of a fastening hole 50 and to be received and mechanically secured by a corresponding fixing groove 11. For example, the fastening member 25 and fixing groove 11 may be positioned with respect to one another so as to be substantially aligned concentric. The fastening member 25 may be formed as a bolt, and the fixing groove 11 of the bare cell 10 may be formed by a shape of a nut to which the bolt may be fastened. Further, the fastening hole 50 of the upper case 30 may be further formed with a seated portion 32 formed to be stepped so that a head portion of the bolt is seated. In alternative embodiments, the fastening member 25 may be formed as a rivet.

Like this, the upper case 30 is coupled with the bare cell 10 by the fastening member 25, thereby to reinforce the fastening force between the protection circuit module 20 and the bare cell 10. Thus, resistance is lowered so the electricity may goodly flow from the bare cell 10 to the protection circuit module 20. As a result, electricity conductivity may be improved in the disclosure as compared with other secondary battery designs.

FIG. 3 is a perspective view showing the upper case 30 according to an embodiment of the present disclosure.

Referring to FIG. 3, the upper case 30 protecting the protection circuit module 20 (refer to FIG. 2) is mounted with the top of the bare cell 10 (refer to FIG. 2). Both sides of the upper case 30 are formed with the fastening hole 50 penetrated from the top surface to the bottom surface. Further, the space portion 31 may be formed in both ends of the lower surface of the upper case 30. At this time, the space portion 31 may be formed on the exterior of the fastening hole 50 so that the space portion 31 is not overlapped with the fastening hole 50 (e.g., towards an outer surface of the upper case, with respect to the fastening hole 50). The space portion 31 is the region in which the upper case 30 does not contact the top surface of the bare cell 10.

Here, the fastening member 25 to be positioned in the fastening hole 50 may be formed as the bolt, and the fastening hole 50 may be further formed with the seated portion 32 formed to be stepped so that the head portion of the bolt is seated.

Like this, the space portion 31 is formed except the portion of the upper case 30 in its entirety transferring the fastening force of the fastening member 25 and therefore, thereby to further reinforce the coupling force between the upper case 30 and the bare cell 10. Further, the loss of the fastening force of the fastening member 25 may be prevented and the quality of the secondary battery may be improved.

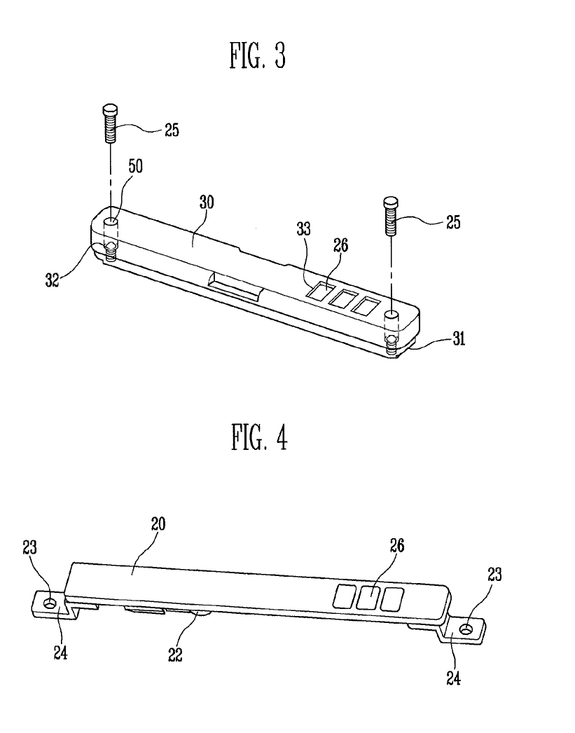

FIG. 4 is a perspective view showing a protection circuit module 20 and fixing member 24 according to an embodiment of the present disclosure, and FIG. 5 is a bottom perspective view showing the protection circuit module 20 and the fixing member 24 according to an embodiment of the present disclosure.

Referring to FIGS. 4 and 5, the top surface of the protection circuit module 20 is formed with the terminal 26 connecting external equipment to the secondary battery. In addition, the bottom surface 20 of the protection circuit module 20 is formed with a secondary protection device 22. The secondary protection device 22 controls current and voltage etc. flowing into the secondary battery, and may be PTC (Positive Temperature Coefficient) or fuse preventing deterioration and explosion of the secondary battery.

In addition, the both sides of the bottom surface of the protection circuit module 20 are formed with the fixing member 24. The bare cell 10 (refer to FIG. 2) is electrically connected to the protection circuit module 20 by the fixing member 24. The fixing member 24 includes a first side formed with the fixing hole 23, and a second side not formed with the fixing hole 23.

One side of the fixing member 24 is corresponded to the fixing groove 11 of the bare cell 10, and the other side of the fixing member 24 may be connected to the bottom surface of the protection circuit module 20. At this time, in the fixing member 24, the first side is stepped to the other side, and the second side may be formed higher. The second side of the fixing member 24 is connected to at least one side of the protection circuit module 20, and therefore, the first side of the fixing member 24 is protruded from the exterior of the end of the protection circuit module 20.

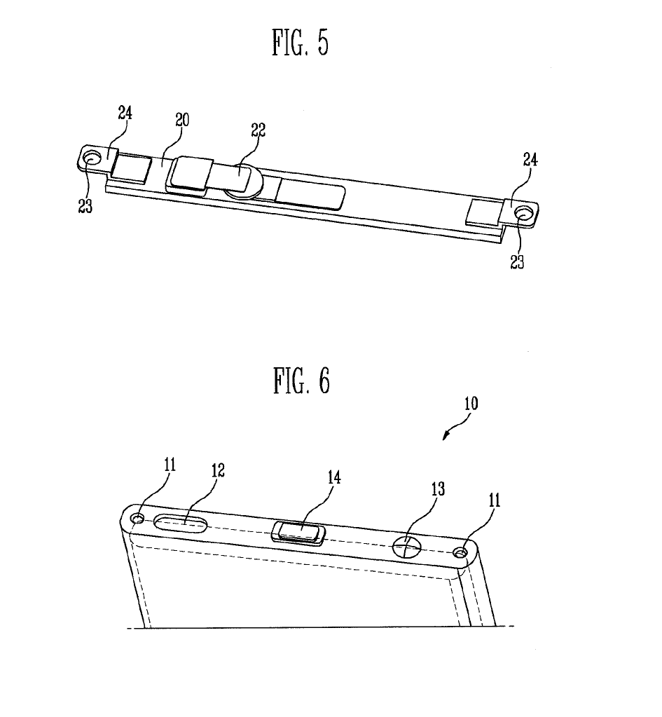

FIG. 6 is a perspective view showing the top of the bare cell 10 according to an embodiment of the present disclosure.

Referring to FIG. 6, the inside of the bare cell 10 is included with an electrode assembly including a negative plate, a positive plate and a separator. Further, the top surface of the bare cell 10 is formed with a vent 12, an electrolyte inlet 13, an electrode terminal 14 and a fixing groove 11.

As described in FIGS. 1 to 5, the fixing groove 11 is coupled with the fastening member 25 (refer to FIG. 2) passing through the fastening hole 50 of the upper case 30 and the fixing hole 23 of the fixing member 24. At this time, the fastening member 25 is formed as the bolt, the fixing groove 11 of the bare cell 10 may be formed by the shape of the nut to which the bolt may be fastened.

Here, the position and shape etc. of the vent 12, the electrolyte inlet 13 and the electrode terminal 14 may be variously varied according to design of the secondary battery.

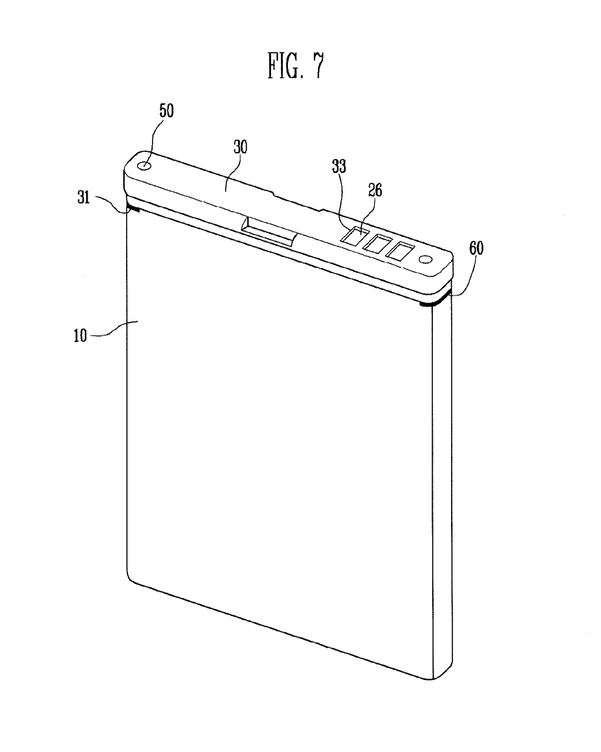

FIG. 7 is a perspective view showing the secondary battery according to another embodiment of the present disclosure.

According to another embodiment of the present disclosure, in FIG. 7, the secondary battery surrounds the bare cell 10 and the protection circuit module (not shown), and includes the upper case 30 on the top of the bare cell 10. In an embodiment, the space portion 31 may be formed in at least one end of the lower surface of the upper case 30. Alternatively, as illustrated in FIG. 7, both sides of the lower surface of the upper case 30 are formed with the space portion 31 not contacting the bare cell 10. The space portion 31 may be further formed with an insulation member 60, and it may be prevented by an insulation member 60 that the fixing member 24 (refer to FIG. 2) is exposed outside. For example, the insulation member 60 may comprise an electrically insulating material and be positioned within at least a portion of the space between the fixing member 24 and the exterior of the upper case 30.

The space portion 31 of the embodiment of FIG. 7 may be spaced by the range of about 0.02 mm to about 0.2 mm from the bare cell 10. If the space between the space portion 31 and the bare cell 10 is spaced by less than about 0.02 mm, there is a risk that the upper case 30 touches the welding bead of the bare cell 10, and therefore, it is unnecessary to form the space portion 31. Further, if the space between the space portion 31 and the bare cell 10 is spaced in excess of about 0.2 mm, an outer wall of the upper case 30 formed with the fastening hole 50 is slimmer, thereby to have the risk to be damaged. Here, it is the most preferable that the space portion 31 is spaced apart from the bare cell 10 by about 0.05 mm.

The space portion 31, which is not affected by the welding bead of the top surface of the bare cell 10, may reinforce the fastening force of the fastening member 25 to be fastened to the fastening hole 50. Thereby, the upper case 30 may be further stably coupled with the bare cell 10.

According to an embodiment of the present disclosure, the fastening defection of the fastening member 25 may be prevented by forming the space portion 31 not contacting the bare cell 10 in the portion of the bottom surface of the upper case 30. Further, the fastening defection is prevented, thereby to improve quality stability of the secondary battery.

While the present disclosure has been described in connection with certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A secondary battery, comprising:
a bare cell including an electrode assembly in the inside thereof and formed with a fixing groove in both sides of a top surface;
a protection circuit module, on a top of the bare cell, electrically connected to the bare cell; and
an upper case surrounding the protection circuit module and formed with the fastening hole in a position corresponding to the fixing groove;
wherein a bottom surface of the upper case is formed with an adhering portion contacting the top surface of the bare cell and a space portion spaced apart at regular intervals from the top surface of the bare cell.

2. The secondary battery according to claim 1, wherein the space portion is formed in at least one side end of the bottom surface of the upper case.

3. The secondary battery according to claim 2, wherein the space portion is formed from the end of the upper case before the position formed with the fastening hole.

4. The secondary battery according to claim 1, wherein the space portion is spaced by the range of about 0.02 mm to about 0.2 mm from the bare cell.

5. The secondary battery according to claim 1, wherein the space portion is spaced by about 0.05 mm from the bare cell.

6. The secondary battery according to claim 1, further comprising a fastening member penetrating the fastening hole of the upper case and fastened to the fixing groove of the bare cell.

7. The secondary battery according to claim 6, wherein the fastening member is formed as a bolt.

8. The secondary battery according to claim 7, wherein the fixing groove is formed in the shape of the nut to which the bolt may be fastened.

9. The secondary battery according to claim 7, wherein the fastening hole of the upper case is formed with a seated portion formed to be stepped so that a head portion of the bolt is seated.

10. The secondary battery according to claim 6, wherein the fastening member is formed as a rivet.

11. The secondary battery according to claim 1, wherein the bare cell and the protection circuit module are electrically connected by a fixing member.

12. The secondary battery according to claim 11, wherein the fixing member includes a first side formed with the fixing hole, and a second side not formed with the fixing hole.

13. The secondary battery according to claim 12, wherein the first side of the fixing member is corresponded to the position of the fixing groove of the bare cell, and the second side of the fixing member is connected to the bottom surface of the protection circuit module.

14. The secondary battery according to claim 12, wherein the fixing member is formed so that the first side is stepped to the second side, and the second side is formed higher than the first side.

15. The secondary battery according to claim 1, wherein the space portion is further formed with an insulation member.

16. The secondary battery according to claim 1, wherein the upper case is further formed with an opening that exposes a terminal of the protection circuit module.

17. The secondary battery according to claim 1, wherein the protection circuit module further includes a secondary protection device.

18. The secondary battery of claim 1, wherein the space portion reduces the area of the upper case contacting the top surface of the bare cell as compared to an upper case without the space portion.

19. The secondary battery of claim 12, wherein the second side of the fixing member positioned the protection circuit module at a selected distance from the top surface of the bare cell.
